(19) United States
(12) Patent Application Publication
(10) Pub. No.: US 2026/0038276 A1
(43) Pub. Date: Feb. 5, 2026

(54) Methods of and Systems for Indentifying and Tracking Vehicles and Vehicle-Assets

(71) Applicant: Streetline Technology LLC, San Mateo, CA (US)

(72) Inventor: Anastasios Zografos, Oakland, CA (US)

(21) Appl. No.: 18/790,671

(22) Filed: Jul. 31, 2024

(51) Int. Cl. G06V 20/54; G06V 20/62; G08G 1/017

(52) U.S. Cl. CPC G06V 20/54; G06V 20/625; G08G 1/0175; G06V 2201/08

(57) ABSTRACT

A method and system accurately identify vehicles during transit and may be used for tracking the vehicle. Images of discrete distinguishing characteristics of a vehicle, respectively, are captured at an unmanned monitoring station. The images are collectively analyzed to produce an individualistic identifier. The individualistic identifier is correlated with data representative of a particular vehicle stored as part of a database of vehicles. Accordingly, the particular vehicle present at the monitoring station can be identified so that the vehicle can be tracked. Furthermore, key assets of the vehicle, such as the tractor, chassis, and cargo box of a truck, can be identified during the process and by the system so that they can be tracked independently of one another.

### BACKGROUND

The present technology pertains to the identification and tracking of vehicles such as trucks, as well as vehicle assets. In particular, the present technology pertains to automated methods of and systems for identifying vehicles or vehicles and their assets at the entrance to and/or exit from a yard where the vehicles and/or their assets are parked for loading/unloading, storage, etc. Likewise, the present technology pertains to automated methods of and systems for identifying vehicles as they move along a roadway (which may be referred to hereinafter as “open road detection” of vehicle-assets). In this way, the locations of the vehicles and/or vehicle-assets can be determined in real time, i.e., the vehicles and vehicle-assets can be tracked and reported to concerned parties.

There are many situations in which an individual vehicle or vehicle-asset needs to be identified at a particular or chosen location. One of these situations is the transporting of shipping containers by truck to a particular destination, i.e., drayage. Drayage is generally considered as entailing the short hauls of the shipping containers from ports or other terminals (yards, depots, etc.) to nearby locations, and may be understood specifically as a truck pickup from or delivery to a seaport, terminal or the like with both the origin and intended destination in the same metropolitan area. Thus, drayage is often referred to as the process of transporting goods over “the first mile”.

In domestic drayage, for example, goods in a marine shipping container are offloaded to the cargo box of a truck and then moved inland. In marine drayage, a marine shipping container is loaded onto a chassis of a truck so that the products remain in the marine container (now cargo box) to the final destination. Every product that is imported or exported, i.e., that arrives at or leaves a port of entry, must be moved by drayage and often more than once. Accordingly, tracking vehicles and vehicle-assets, e.g. trucks and/or their cargo boxes, at any port is crucial to maintain efficiency in the supply chain of goods. Congestion at a port, in particular, can lead to major delays in delivering goods to their final destination and resulting missed delivery deadlines and financial penalties to operators.

For these reasons, operators and other interested parties associated with drayage want to know such information as which vehicles have entered the port, which ones have left, when did they leave, what vehicle-assets did they have when they left, etc. Currently, however, the level of sophistication of identifying and monitoring vehicles at locations like gates leading from and/or into seaports and the like, i.e., within the “first mile”, is minimal at best. In fact, the identification of vehicles and their assets as the means to track them is often carried out by workers stationed at the gates, by entering information manually into logs. This leads to inefficiencies and can be the source of errors. Obviously, once made these errors are difficult to identify and rectify.

There are also many situations in which the type of vehicle traveling on a roadway needs to be confirmed. For example, there may be a case in which only a particular type of vehicle is allowed to operate on a particular roadway, the time a vehicle is allowed to travel on a particular roadway is restricted, or the duration of vehicle operation within a given time frame is restricted. And so, the entity that is restricting the operation of vehicles in any of these or other ways may be interested in identifying the particular vehicles that are traveling on or to and from various points along a roadway. Just as one example, the state of California is currently limiting the year, make and model of trucks that can be used for drayage around seaports, and thus trucks are registered with the state for this purpose and workers at ports in California are charged with ensuring that only compliant trucks are operating around seaports in the state.

### SUMMARY

Accordingly, it is one object of the present technology to provide an automated method of identifying vehicles with a high degree of accuracy at a particular location(s) and by which the vehicles can be tracked.

It is also an object of the present technology to provide an automated method of identifying vehicle-assets with a high degree of accuracy at a particular location(s) and by which the vehicle-assets can be tracked.

It is likewise an object of the present technology to provide a system of identifying vehicles with a high degree of accuracy at a particular location(s) and by which the vehicles can be tracked.

Another object of the present technology to provide a system by which vehicle-assets can be identified with a high degree of accuracy at a particular location(s) and by which the vehicle-assets can be tracked.

According to one aspect of the present technology, there is provided a method of identifying a vehicle during transit for use in tracking the vehicle, comprising: capturing images of discrete distinguishing characteristics of a vehicle, respectively, at a monitoring station, collectively analyzing the images captured at the monitoring station to produce an individualistic identifier, and correlating the individualistic identifier with data representative of a particular vehicle, to thereby identify the particular vehicle present at each of the one or more stations, whereby the vehicle can be tracked.

According to another aspect of the present technology, there is provided a method of identifying a vehicle and its assets during transit for use in tracking the vehicle and its assets, the method comprising: capturing images of distinguishing characteristics of vehicle-assets, respectively, at a monitoring station, analyzing the images collectively to identify each of the vehicle-assets from the respective image thereof and to produce an individualistic identifier, storing information identifying the vehicle-assets which were present at the station, whereby each of the vehicle-assets can be tracked irrespective of one another, and correlating the individualistic identifier with data representative of a particular vehicle to thereby identify the particular vehicle present at the monitoring station, whereby the vehicle can be tracked.

According to still another aspect of the present technology, there is provided a system of identifying vehicle assets, comprising: a monitoring station comprising cameras positioned to capture a plurality of images of a vehicle present at the station, and a computer in a network communication with the monitoring station so as to receive data from images captured by the cameras at the monitoring station. The computer has memory stores data representative of each of a plurality of vehicles, and operating instructions, and at least one processor operatively connected to the memory. The at least one processor is configured to execute the operating instructions to process the data using an image recognition process to thereby discern a plurality of discrete distinguishing characteristics of the vehicle, and correlate the discrete distinguishing characteristics with data in the memory representative of a particular vehicle. As a result, the particular vehicle which was imaged at the station is identified.

### BRIEF DESCRIPTION OF THE DRAWINGS

These and other objects, features and advantages of the present technology will be better understood from the detailed description of preferred embodiments and examples thereof that follow with reference to the accompanying drawings, in which:

FIG. 1A is an explanatory diagram of an example of a method of identifying a vehicle and optionally its assets according to the present technology, for use in tracking the vehicle and optionally its assets;

FIG. 1B is an explanatory diagram of the method of FIG. 1 in more detail, according to the present technology;

FIG. 2 is a conceptual diagram showing examples of monitoring stations according to the present technology;

FIG. 3 is a conceptual diagram of an example of the present technology as applied to a terminal yard;

FIG. 4 is a conceptual diagram of one example of a utility of the present technology;

FIG. 5 is a block diagram of an example of a machine of a system according to the present technology;

FIGS. 6A and 6B are each a photographic illustration of a monitoring station of a system according to the present technology;

FIG. 6C is an enlarged view of part of the monitoring station shown in either FIG. 6A or FIG. 6B;

FIGS. 7A is a schematic diagram of part of another monitoring station according to the present technology;

FIG. 7B is an explanatory diagram showing the use of the monitoring station the part of which is shown in FIG. 7A; and

FIG. 8 is a schematic diagram of an example of networking infrastructure of a system according to the present technology.

### DETAILED DESCRIPTION

Embodiments of the present technology and examples thereof will now be described more fully in detail hereinafter with reference to the accompanying drawings. In the drawings, elements may be shown schematically for ease of understanding. Also, like numerals and reference characters are used to designate like elements throughout the drawings. Certain examples of a machine constituting the present technology may be described and illustrated in terms of blocks which carry out a described function or functions. These blocks, which may be referred to herein as modules or the like, are physically implemented by analog and/or digital circuits such as logic gates, integrated circuits, microprocessors, microcontrollers, memory circuits, passive electronic components, active electronic components, optical components, hardwired circuits and the like, and may be driven by firmware and/or software of non-transitory computer readable media (CRM). In the present disclosure, the term non-transitory computer readable medium (CRM) refers to any medium that stores data in a machine-readable format for short periods or in the presence of power, such as a memory device or Random Access Memory (RAM). The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the examples may be physically separated into two or more interacting and discrete blocks and conversely, the blocks of the examples may be physically combined into more complex blocks while still providing the essential functions of the present technology.

The terminology used herein for the purpose of describing particular embodiments of the present technology is to be taken in context. For example, the term “comprises” or “comprising” when used in this disclosure indicates the presence of stated features or steps in a process but does not preclude the presence of additional features or steps. The term “asset” of a vehicle, or “vehicle-asset”, will be understood as referring to any major discreet part of the vehicle that maybe separated from the remainder of the vehicle and is conventionally parked or stored temporarily. In the case of trucks, for instance, vehicle-assets may include the tractor of the truck, a chassis of the truck (i.e., a trailer) or a cargo box, which may be a shipping container, carried by the chassis. The term “number” as in vehicle license plate number will be understood as a series of numbers, letters or alphanumerics by which that vehicle or vehicle-asset is identifiable. Thus, a license plate number, container number, chassis number, etc. may each be a distinguishing characteristic of a vehicle or vehicle-asset as the case may be.

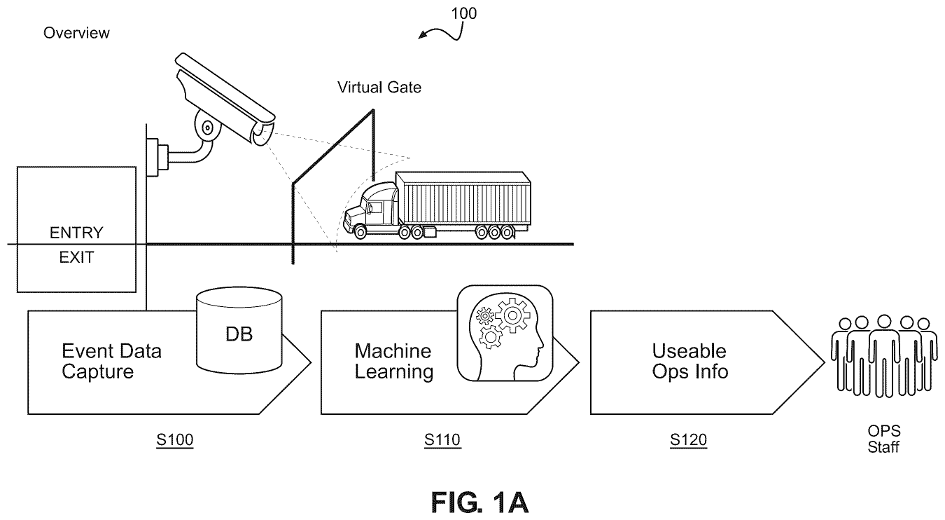

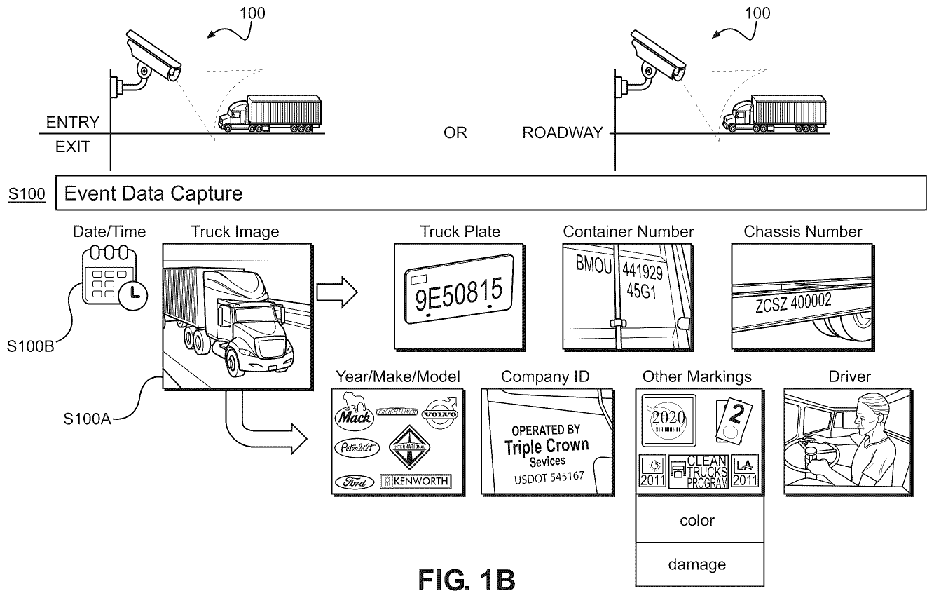

Referring now to FIGS. 1A and 1B, examples of a method according to the present technology include an event data capture step S100, an image analysis step S110 and a data reporting step S120. The event data capture step S100 includes capturing digital images of discrete distinguishing characteristics of a vehicle (S100A), respectively, at a monitoring station 100, which step may be referred to hereinafter as “image acquisition”. The digital images are stored to form a database DB. The event data capture step S100 may also include providing the images in the database DB with a date and time stamp (S100B) indicating the day and time at which the images were captured at the monitoring station 100.

As will be described in more detail below, one example of the monitoring station 100 includes high-resolution cameras strategically placed at key points such as entry and exit gates, loading docks, and checkpoints within a logistics facility. With respect to the image acquisition, these cameras capture multiple images of each vehicle as it passes through these points, with the cameras oriented at all relevant angles necessary to capture images of relevant details of the vehicles. The captured images undergo preprocessing to enhance their quality and prepare them for analysis. Such an image enhancement preprocessing step may include the removal of any visual noise that could interfere with the image analysis step S110, an image normalization process that adjusts the brightness and contrast to ensure consistency across all images, and an image cropping and resizing step that enables focusing on the main regions of interest and resizing the images to a standard dimension suitable for the image analysis step S110.

The image analysis step S110 comprises an image recognition process of analyzing the captured images collectively to produce an individualistic identifier, and correlating the individualistic identifier with data representative of a particular vehicle, to thereby identify the particular vehicle present at the monitoring station 100. To this end, a a machine learning (ML) model may be used. The information identifying the particular vehicle can be reported out to interested individuals in a Useable Ops Info (information) reporting step S120. Accordingly, the vehicle Useable Ops Info allows the vehicle to be tracked and in this respect, artificial intelligence (AI) may be used to implement the present technology.

In these examples, the vehicle is a truck although the present technology is applicable to any vehicle which a party/entity is interested in identifying as being present at a particular site or location. In this respect, the presence of the vehicle at the monitoring station 100 may be of interest as indicating that the vehicle is entering or exiting a site, is present within a yard or is traveling in a particular zone of a roadway, etc. In any case, a truck will be used for descriptive purposes only. The truck may be a tractor trailer including a tractor, a chassis and a cargo box mounted to and carried by the chassis. Because these parts of the trucks can be parked or stored separately from each other, they will be referred to herein as vehicle-assets. In examples of the present technology, vehicle-assets may also be identified and tracked independently of one another. Thus, the image analysis step S110 may include identifying vehicle-assets from the images captured at the monitoring station 100, and storing information identifying the vehicle-assets, whereby each of the vehicle-assets can be tracked irrespective of one another.

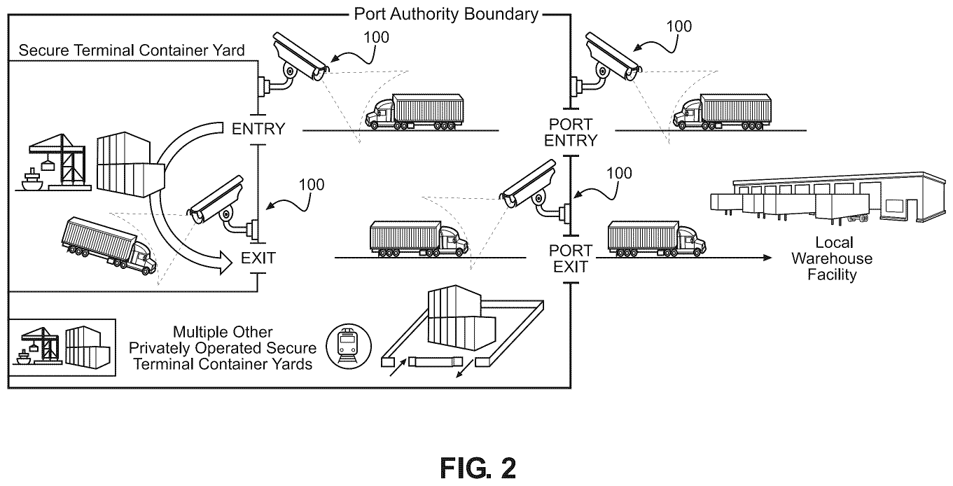

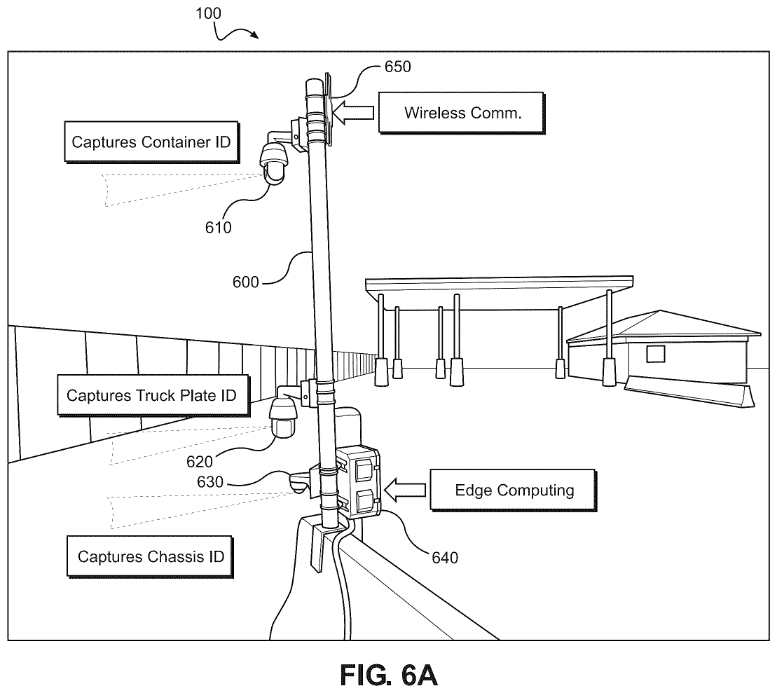

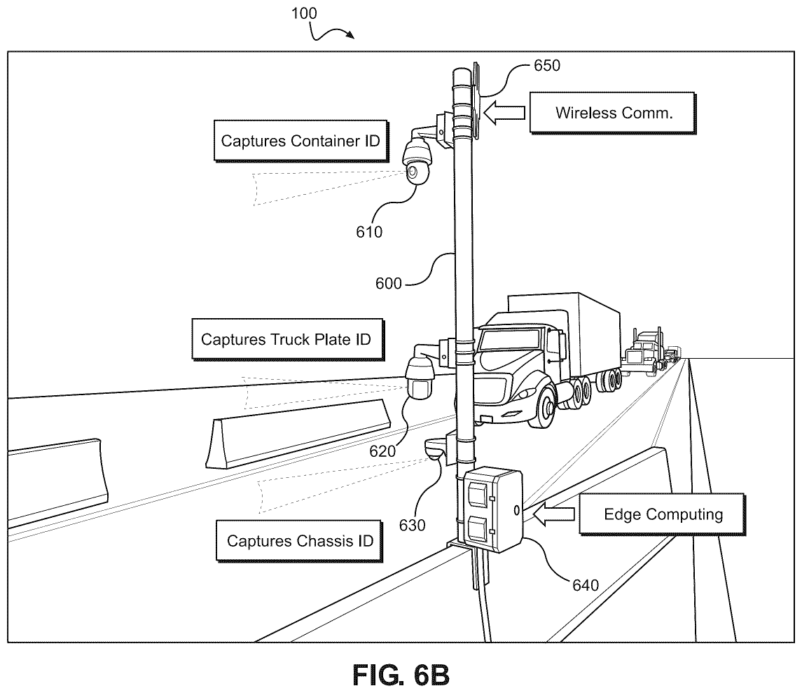

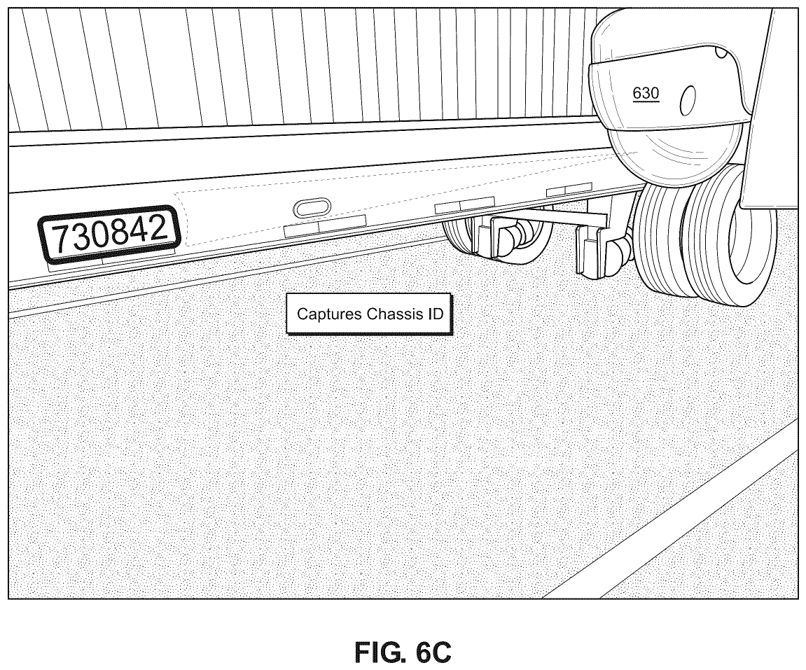

Referring in particular to FIG. 2, the monitoring station 100 may constitute a portal in the form of an actual or virtual gate. For example, the monitoring station 100 may constitute the portal to a seaport monitored by a Port Authority such as an actual gate between the port exit and a local warehouse, i.e., where drayage takes place, or an actual gate to and/or from any other yard. Alternatively, the monitoring station 100 may constitute a virtual gate to a secure part of a container yard. The monitoring station 100 could alternatively constitute a portal located along a highway (see FIG. 6, for example), especially within say a certain radius of a port boundary or yard (one mile, for example) so that actual arrival of the vehicle at the port or yard can be predicted, which prediction from a mile away would not be possible using GPS. As another example, the monitoring station 100 could be provided and even replicated along portions of a roadway having travel restrictions which allow only newer trucks (e.g., 2014 or later) or low-emission (e.g., zero emission) vehicles to travel along those portions. In this way, the present technology could be used to detect the violators of the travel restrictions. Also, in FIGS. 1A and 1B only one camera is shown at the monitoring station 100 but in examples of the present technology, the monitoring station 100 comprises a plurality of cameras as will be described in more detail later on. The cameras may be provided with auto-detection, known per se, to automatically capture images of a vehicle while it is stopped at or traveling past the monitoring station 100.

Referring back to FIG. 1B, the images of the discrete distinguishing characteristics of the vehicle captured (S100A) may include respective images of the license plate number of the truck, the container number provided on the back of the cargo container according to industry standards, and the chassis number of the truck provided on the side of the chassis or trailer, especially when it is desirous to track these vehicle-assets independently of one another. Each of these key artifacts may be identified using OCR software in the image analysis step S110. Reliance may be had on the front license plate, because if the vehicle is a tractor-trailer, a trailer or chassis attached to the tractor could obscure the back plate of the tractor. In the case of a tractor requiring pick-up of a particular chassis, the present technology is useful in tracking who has the chassis and then which tractor has which chassis and at what point in time. Likewise, the present technology is useful in tracking the combination of all three vehicle-assets—the tractor, chassis, and container—to determine whether they are arriving at or departing from the port altogether or separately.

The discrete distinguishing characteristics of the vehicle captured (S100A) may also or alternatively include respective images of one or more of decals applied to the tractor of the truck (e.g., decals on a side door of a tractor of a truck indicating year, make model), logos, dents and scratches (vehicle damage), a colored portion of the truck, other vehicle markings, and an image of the vehicle driver (identified using facial recognition software in the image analysis step S110), all useful for identifying a particular vehicle especially if for any reason it isn't possible to obtain an accurate license plate read in the image analysis step S110.

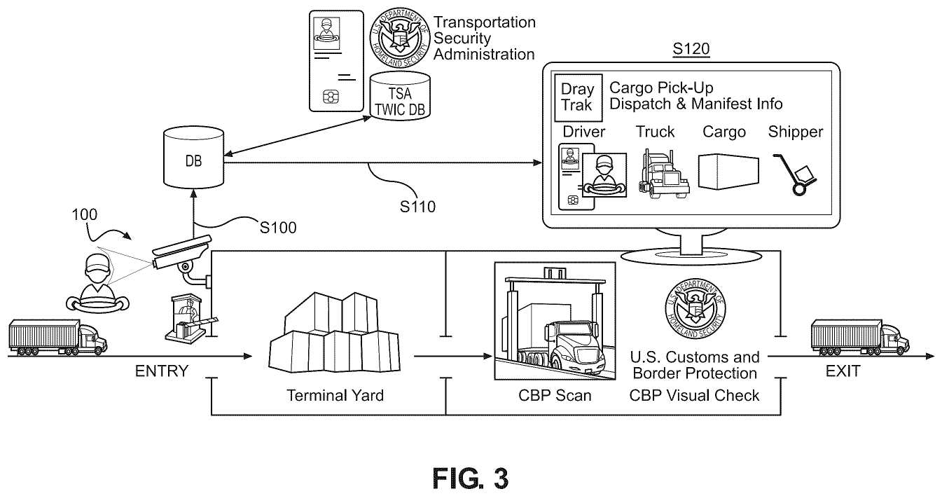

FIG. 3 illustrates an example of the present technology as applied to a marine terminal yard monitored by U.S. Customs and Border Protection. In this example, the monitoring station 100 provides a virtual gate at the U.S. border. As shown in this figure, the terminal yard has entry and exit points, and the yard is that type provided with cranes to load/offload marine containers from ships. In these cases, Border Patrol of U.S. Customs and Border Protection has offices only at the exits of these yards. As a federal agency, U.S. Customs and Border Protection may have some concern about a ship that has come into port. Thus, Border Patrol conducts random Customs and Border inspections of marine containers in the yard as they are leaving the yard and officially entering the U.S. Thus, U.S. Customs and Border Protection could use advanced information about who's entering the yard to pick up a particular container, which information can be provided by the present technology in the form of an advance alert before the driver arrives at or as the driver is entering the terminal yard. More specifically, U.S. Customs and Border Protection may want to run the driver of the truck scheduled to pick up the container on their system to see if there's anything they need to flag them for, and then intercept them on the way out if there is cause for concern.

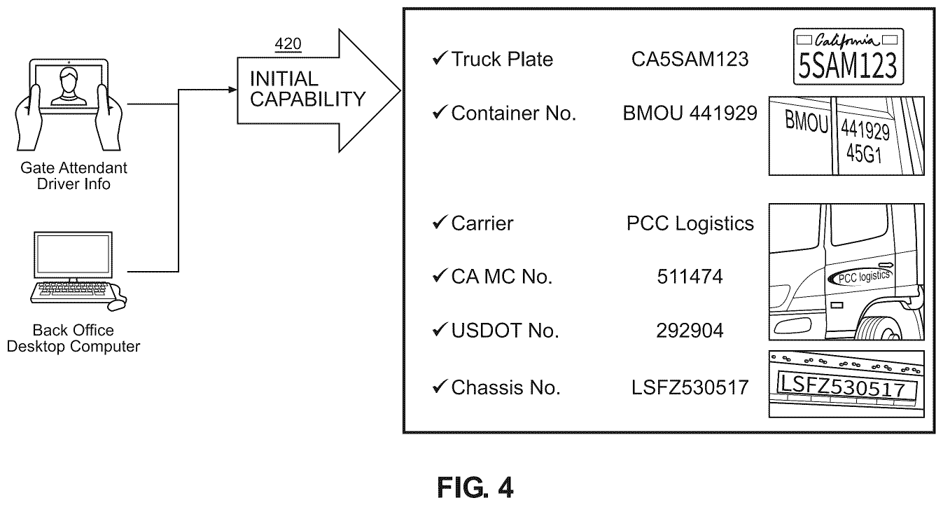

FIG. 4 illustrates examples of the use of some of the output of the Useable Ops Info reporting step, namely, information identifying and tracking vehicle-assets (initial capability 420 of the Useable Ops Info reporting). The information is reported to a back-office computer or a ruggedized work tablet in the hands of an attendant walking the yard. This information allows the attendant to police the yard. For example, a command is provided to the attendant to find a particular person that may be operating one of the vehicles in the yard or is about to leave the yard with a vehicle-asset. The Useable Ops Info reporting step (S120 in FIG. 1) may convert images of discrete distinguishing characteristics of the vehicle into a list that allows the attendant to perform various tasks in the yard associated with policing the yard.

As mentioned above, the image information shown in FIG. 4, as one example, may be processed in the image analysis step S110 (FIG. 1A) using a machine learning (ML) model to produce an individualistic identifier. In one example, the core of the image analysis step 110 is object detection, where the system identifies and locates details of the vehicle-assets (tractor, chassis, and cargo box within the images. The machine learning (ML) model according to an example of the present technology is constituted by a convolutional neural network (CNN) trained on a large dataset of labeled images of various types of truck tractors, chassis, and cargo boxes (which include shipping containers for this purpose) under different lighting conditions and angles.

The trained model generates bounding boxes around the tractor, chassis, and cargo boxes, effectively isolating these components from the rest of the image(s).

Next, in a feature extraction process, each region within a bounding box is processed to extract unique features that can be used for identification of the vehicle and/or the vehicle-assets. Again, with reference to FIG. 1B, these unique features may include one or more of the truck's license plate number, make, model, and color. Re the chassis, the unique features may include unique identification numbers, structural characteristics, and unique markings. For the cargo box (a shipping container when the present technology is applied to drayage), the unique features may include container identification number and container size, type, and condition (e.g., presence of dents, rust, or labels). In the cases in which the unique features are alphanumerics, the machine system may be augmented with an OCR (optical character recognition function to “read” the numbers and/or letters.

With the features extracted, the system proceeds to classify and identify each vehicle-asset by matching the unique features against a pre-existing database of registered trucks, and assigns an individualistic identifier to the truck based on at least two of the unique features. This database contains detailed information about each truck and its assets (tractor, chassis, cargo box if applicable), including ownership, maintenance history, and current status. According to examples of the present technology, this classification and identification routine may be performed by executing advanced ML algorithms, such as support vector machines (SVM) or deep learning classifiers. These algorithms learn from the database and continuously improve their matching capabilities. The final step, i.e., the Useable Ops Info (information) reporting step S120 (FIG. 3) integrates the identifying data (data identifying the truck and the vehicle-assets thereof) into a system database in such a way that reports identifying the truck and its vehicle-assets imaged at the monitoring station 100 can be produced. The reports can be updated in real-time, allowing for accurate vehicle and vehicle-asset tracking and monitoring.

Thus, a system implementing the present technology correlates with data representative of a particular vehicle to thereby identify the particular vehicle which was imaged at the station. As is clear from the description above, such a system according to the present technology comprises one or more of the aforementioned monitored station(s) having cameras positioned to capture a plurality of images of a vehicle present at the station, and a computer system in a network communication with the monitoring station(s) so as to receive data from images captured by the cameras at the monitoring station(s).

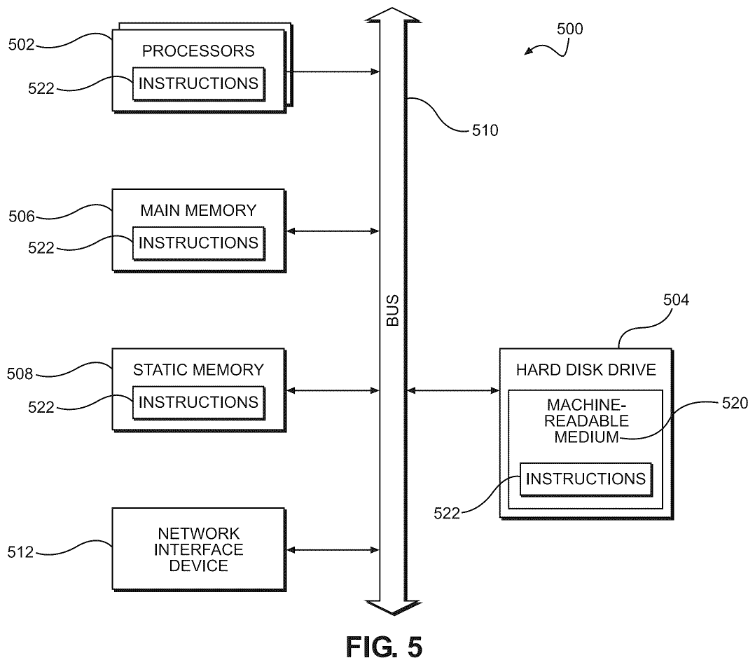

FIG. 5 illustrates a machine in the exemplary electronic form of such a computer system 500, within which a set of instructions for causing the machine to perform at least the above-described steps S110 and S120 can be executed. In various embodiments, the machine is connected (e.g., networked) to other machines, such as a server(s) which stores the aforementioned database representative of vehicles. In a networked deployment, the machine can operate in the capacity of a server or a client machine in a server-client network environment, or as a peer machine in a peer-to-peer (or distributed) network environment. The machine can be a desktop or laptop PC, a tablet PC, or any machine capable of executing a set of instructions (sequential or otherwise) that specify actions to be taken by that machine. Furthermore, while only a single machine is illustrated, the term “machine” shall also be taken to include any collection of devices that individually or jointly execute a set (or multiple sets) of instructions to perform any one or more of the methods and/or steps discussed herein. Thus, the machine may also include a display such as an LCD on which the Useable Ops Info (S120 in FIG. 1) or list shown in FIG. 4 can be displayed.

The example computer system 500 includes a processor or multiple processors 502 (CPUs and/or GPUs, for example), a hard disk drive 504, a main memory 506, and a static memory 508, which communicate with each other via a bus 510. The computer system 500 may also include a network interface device 512, e.g., a wireless communications device. The hard disk drive 504 may include a non-transitory computer-readable medium 520, which stores one or more sets of instructions 522 for carrying out or executing any of the functions/processes described herein. The instructions 522 can also reside, completely or at least partially, within the main memory 506, the static memory 508, and/or within the processors 502 during execution thereof by the computer system 500.

Although the non-transitory computer-readable medium 520 is shown as a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine (such as algorithms for processing the image data to produce the vehicle identifier from the collection of images captured at a monitoring station 100) and that causes the machine to perform any one or more of the steps, functions, methods of the present technology, or that is capable of storing, encoding, or carrying data structures (such as the database of vehicles to be identified and tracked) utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks (DVDs), Random Access Memory (RAM), Read-Only Memory (ROM), and the like.

A GPU of the computer system of FIG. 5 (one of the processors) may be configured as the CNN providing the machine learning (ML) model described above. More specifically, the GPU may include an Input Layer, multiple Convolution Blocks, a Feature Extraction Block, a Bounding Box Prediction Block, and an Output Layer. The input layer is an interface by which the enhanced images (of distinguishing characteristics of the vehicle-assets) are fed into the network. They may each be a 3D tensor with width, height, and channels (e.g., RGB). Each Convolution Block may include a Convolution Layer, an Activation Layer and optionally a Pooling Layer. The Convolution Layer applies filters (kernels) to the input image, extracting features like edges, lines, and shapes. The output is a feature map. And so, filters for each of the distinguishing characteristics of the vehicle-assets are provided. The Activation Layer introduces non-linearity, helping the network learn the complex patterns necessary to identify the vehicle from its various distinguishing characteristics. An example of an Activation Layer is a rectified linear unit (ReLu). The Pooling Layer (optional) reduces the dimensionality of the feature map by downsampling. The Pooling Layer may use Max Pooling or Average Pooling to this end.

FIGS. 6A and 6B illustrate examples of the unmanned monitoring stations 100 according to the present technology, with FIG. 6A showing an example in which a monitoring station is situated in front of a gate leading out of a yard and FIG. 6B showing an example in which a monitoring station is disposed along a roadway. In the example of FIG. 6A, the vehicle identification produced by capturing images at the station is used for flagging vehicles leaving the yard by personnel, e.g., Border Patrol, provided with an office to the right of the gate in the photo. In each example, the monitoring station comprises a pole 600, high-resolution (at least 300 PPI) digital cameras 610, 620 and 630 each mounted to the pole, an edge computing device 640 also mounted to the pole and operatively connected to the cameras 610, 620 and 630 so as to receive the digital images from the camera and produce image data therefrom, and a wireless communications device operatively connected to the edge computing device 640 to receive data from the edge computer device 640 and transmit the same to interested personnel. The edge computing device may form part of the computer system 500 of FIG. 5.

The edge computing device 640 is designed to bring computational power closer to the data source (output of the cameras 610, 620 and 630), thereby reducing latency, enhancing processing speeds, and improving overall system efficiency. The hardware components (edge computing architecture) that constitute the edge computing device 640 include but are not limited to an edge device, an edge gateway, an edge server and a power management system, and may also include an edge gateway, an edge network communication component, and a security module. Edge devices are the frontline components in edge computing architecture. They are responsible for data collection and initial processing and so, the edge device of edge computing device 640 may be an image processor used to process the images captured by the cameras 610, 620, 630. Edge gateways serve as intermediaries between edge devices and the cloud or central data centers. They may aggregate data from multiple devices, perform preliminary data processing, and ensure secure data transmission. Data Aggregation consolidates data from various edge devices to reduce data traffic. Local processing includes preprocessing tasks such as data filtering, normalization, and encryption. Connectivity supports multiple communication protocols (e.g., Wi-Fi, Ethernet, Zigbee) for device interconnection. Edge servers are robust computing units located close to the data source. They provide substantial processing power to handle more complex computations and data analytics that cannot be efficiently managed by edge devices or gateways. Thus, the edge server of the edge computing device 640 may comprise a multi-core CPU or GPU to manage the intensive computational tasks of the machine learning (ML) described above. Local data storage solutions (e.g., SSDs, HDDs) are used for temporary data retention and caching. Virtualization enables the running of multiple virtual machines or containers for isolated workloads.

The network infrastructure of the edge computing device 640 ensures reliable and fast data transmission between its edge device, gateway, server, and eventually to the central cloud. Routers and Switches direct data traffic efficiently between networked devices. A Network Interface Card (NIC) may be employed to facilitate high-speed data transfer and connectivity. A Wireless Access Point (WAP) may be used to enable wireless communication when the system according to the present technology is provided in a remote location that does not have access to communication lines like cable, like where the portals of a system according to the present technology may be located. The power management system may be used to maintain the uptime and reliability of the edge computing device 640, which is especially advantageous in remote environments. The power management system of the edge computing device 640 may comprise an uninterruptible power supply (UPS) to provide backup power during outages to prevent data loss and hardware damage, a power distribution unit (PDU) to distribute electrical power to various devices within the edge architecture, and an energy harvesting system that supports the capture of renewable energy sources (e.g., solar, wind) to power the edge computing device 640 sustainably.

Security subsystems protect sensitive data and maintain system integrity and include trusted platform modules (TPMs) to provide hardware-based security functions such as encryption and secure boot, hardware security modules (HSMs) dedicated for managing cryptographic keys and performing encryption/decryption operations, and secure boot mechanisms that ensure that only trusted software is executed during the boot process.

Each of these components may be battery-powered because there may not be any fiber or power available to the pole 600. In other examples, the unmanned monitoring stations of these examples could be parts of existing light poles and employ the source of power provided to the poles.

Furthermore, in these examples, the cameras 610, 620 and 630 are mounted to the pole at different heights from one another above the ground so as to capture images of different parts of the vehicle when present at the station. And to this end, at least one of the cameras 610, 620 and 630 may face in a first direction and another camera faces in a second direction perpendicular to the first direction. For example, the cameras 610 and 620 are disposed at positions along the pole with camera 610 above camera 620 and are oriented (i.e., with their lenses facing) in opposite directions parallel to the path of travel of the truck to capture images of the truck that will include the container ID number and truck license plate, respectively. On the other hand, the camera 630 is disposed beneath the cameras 610 and 620 on the pole and is oriented (i.e., with its lens facing) in a direction perpendicular to the path of travel of the truck to capture an image of the truck that will contain the chassis identification number (FIG. 6C).

With respect to the edge computing device 640, image processing of the digital images (which may be in video form) captured by the cameras 610, 620, 630 is carried out at the pole 600 so that the data reporting over the wireless communications device 650 from (the WAP) of the edge computing device 640 can be small in respect of bandwidth needs. That is, by providing the edge computing device 640, it is unnecessary to send video over a cellular backhaul. Only bits of data need to be transmitted from the pole 600 so that bandwidth costs from a wireless service provider are kept to a minimum. From there, the data may be transmitted to the cloud where it may be accessed by parties interested in tracking the vehicle.

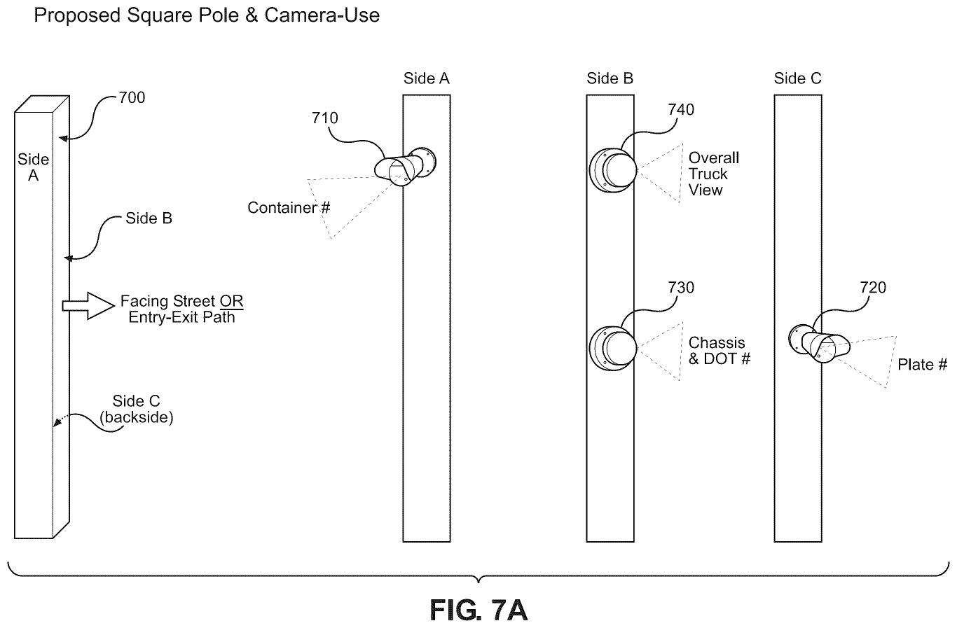

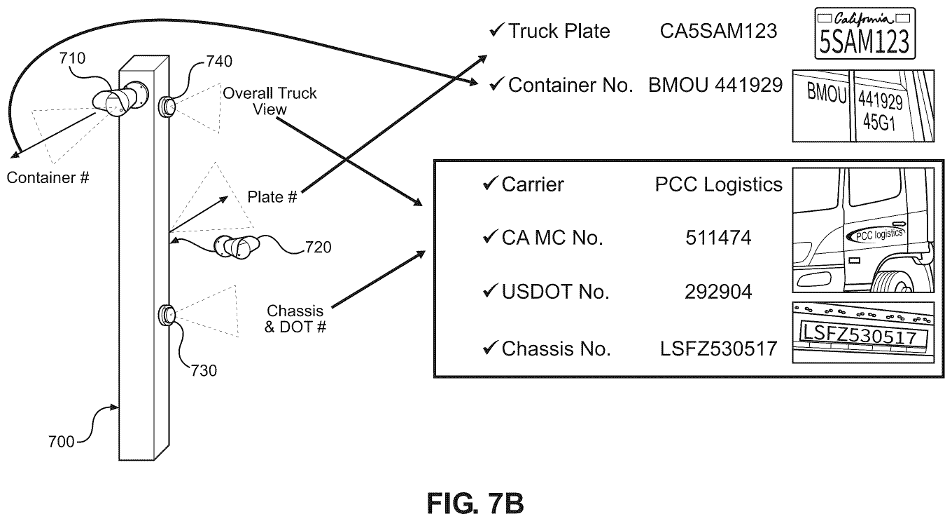

FIGS. 7A and 7B show another example of an unmanned monitoring station, in which the pole 700 has a rectangular, e.g., square, horizontal cross section, and four cameras 710, 720, 730 and 740 mounted thereto. The pole 700 may be ten feet high, for example. These examples may thus be unique detection units specifically for detecting vehicles. The cameras 710, 720, 730 and 740 are mounted to various sides of the pole 700 as each oriented in the direction which the side of the pole 700—to which they are mounted—faces. In this example, a fourth camera 740 is provided at substantially the same height as the camera 710 but on a different side of the pole 700 so as to be oriented in a different direction from the camera 710. The fourth camera 740 is positioned to capture an overall image of the truck for confirmation of various distinguishing characteristics of the truck.

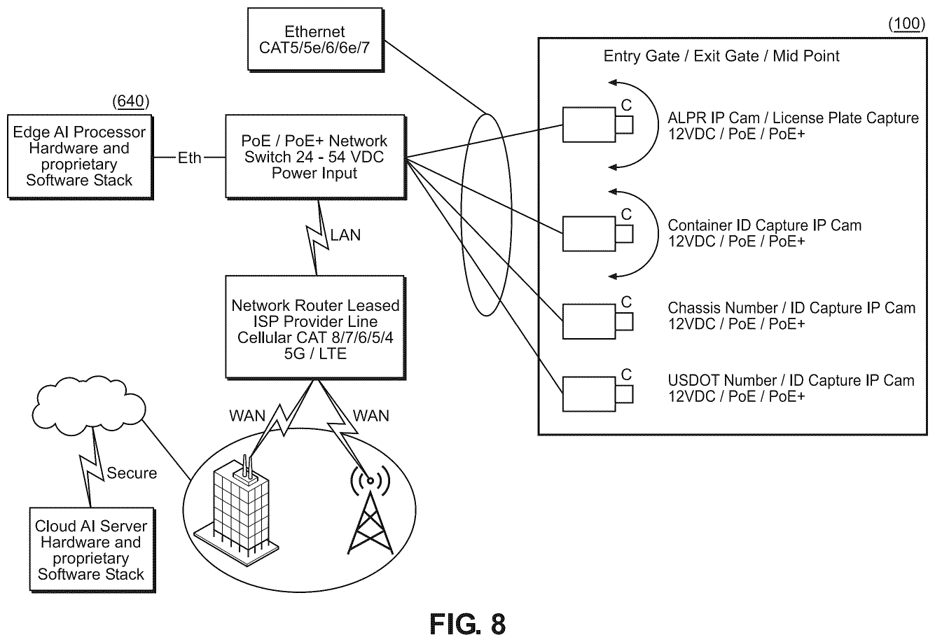

Referring now to FIG. 8, in this example of network infrastructure, the cameras, e.g., cameras 710, 720, 730 and 740 in FIGS. 7A and 7B, are ethernet-connected to a network switch provided with power. Likewise, the processor(s) of the edge computing device (like that described with reference to FIGS. 6A and 6B with regard to refence numeral 640) with software stack are also be networked with the switch through an ethernet connection. A network router provides communications to the edge computing device by means of a wireless communications device (like that described with reference to FIGS. 6A and 6B with regard to reference numeral 650) on the pole. Alternatively, there might be fiber to the pole in which case the wireless communications device is unnecessary. In either cases, data would be transmitted through a network to AI software provided on the cloud through secure means, and by way of either a cellular tower or through some other network connection. The AI software is configured to produce the Useable Ops Info, for example, in a system according to the present technology.

As is clear from the description above, the present technology offers enhanced accuracy in vehicle detection and thus vehicle tracking, and can also be used to track vehicle-assets independently of one another. Furthermore, although the present technology has been described above in detail with respect to various embodiments and examples thereof, the technology may be embodied in many different forms to implement the present invention. Thus, the present invention should not be construed as being limited to the embodiments and their examples described above. Rather, these embodiments and examples were described so that this disclosure is thorough, complete, and fully conveys the present invention to those skilled in the art. Thus, the true spirit and scope of the present invention is not limited by the description above but by the following claims.

What is claimed is:

1. A method of identifying a vehicle during transit for use in tracking the vehicle, comprising:
capturing, at a monitoring station, images of discrete distinguishing characteristics of a vehicle, respectively;
analyzing the images, captured at the monitoring station, collectively to produce an individualistic identifier; and
correlating the individualistic identifier with data representative of a particular vehicle, to thereby identify the particular vehicle present at the monitoring station, whereby the vehicle can be tracked.

2. The method as claimed in claim 1, wherein the capturing comprises capturing the images of the discrete distinguishing characteristics using a plurality of cameras at the station.

3. The method as claimed in claim 1, wherein at least one of the discrete distinguishing characteristics is unique to the individual vehicle.

4. The method as claimed in claim 3, wherein the discrete distinguishing characteristics include at least two characteristics selected from the group consisting of license plate number of the vehicle, container number of a cargo box of the vehicle, and chassis number of a chassis of the vehicle.

5. The method as claimed in claim 4, wherein the capturing comprises capturing at the images of the discrete distinguishing characteristics using a plurality of cameras disposed at different heights above the ground from each other at the monitoring station.

6. The method as claimed in claim 1, wherein the discrete distinguishing characteristics include at least one characteristic selected from the group consisting of coloration of a portion of the vehicle, sign of vehicle damage, marking on the vehicle, and driver of the vehicle.

7. The method as claimed in claim 1, wherein the monitoring station is disposed beside a portal between a roadway and a site where vehicles are parked, and the images are captured while the vehicle is stationary at or moving through the portal.

8. The method as claimed in claim 1, wherein monitoring stations are spaced along a roadway from each other, images of the vehicle are captured at each of the monitoring stations, and the images are used to identify the presence of the particular vehicle at each of the monitoring stations.

9. The method as claimed in claim 1, wherein the analyzing of the images comprises performing an image recognition process using artificial intelligence (AI).

10. A method of identifying a vehicle and its assets during transit for use in tracking the vehicle and its assets, the method comprising:
capturing, at a monitoring station, images of distinguishing characteristics of vehicle-assets, respectively;
analyzing the images collectively to identify each of the vehicle-assets from the respective image thereof and to produce an individualistic identifier;
as a result of the analysis, storing information identifying the vehicle-assets which were present at the station, whereby each of the vehicle-assets can be tracked irrespective of one another; and
correlating the individualistic identifier with data representative of a particular vehicle to thereby identify the particular vehicle present at the monitoring station, whereby the vehicle can be tracked.

11. The method as claimed in claim 10, wherein the discrete distinguishing characteristics include at least two characteristics selected from the group consisting of license plate number of the vehicle, container number of a cargo box of the vehicle, and chassis number of a chassis of the vehicle.

12. The method as claimed in claim 11, wherein the capturing comprises capturing the images of the discrete distinguishing characteristics using a plurality of cameras disposed at different heights above the ground from each other at the station.

13. The method as claimed in claim 11, wherein the monitoring station is disposed beside a portal between a roadway and a site where vehicles are parked and/or vehicle-assets are stored, and the images are captured while the vehicle is stationary at or moving through the portal.

14. The method as claimed in claim 11, wherein the analyzing of the images comprises performing an artificial intelligence (AI) image recognition process on the images.

15. A system of identifying vehicle assets, comprising:
a monitoring station comprising cameras positioned to capture a plurality of images of a vehicle present at the station; and
a computer in a network communication with the monitoring station so as to receive data from images captured by the cameras at the monitoring station,
the computer having memory storing data representative of each of a plurality of vehicles, and operating instructions, and
at least one processor operatively connected to the memory and configured to execute the operating instructions to process the data using an image recognition process to thereby discern a plurality of discrete distinguishing characteristics of the vehicle, and correlate the discrete distinguishing characteristics with data in the memory representative of a particular vehicle and thereby identify the particular vehicle which was imaged at the station.

16. The system as claimed in claim 15, wherein the monitoring station comprises a pole to which the cameras are mounted at different heights from one another above the ground so as to capture images of different parts of the vehicle when present at the station.

17. The system as claimed in claim 16, wherein at least one of the cameras faces in a first direction and another camera faces in a second direction perpendicular to the first direction.

18. The system as claimed in claim 15, comprising an edge computing module mounted to the pole and operatively connected to the cameras, a remote server, and a wireless communication module connecting the edge computing module to the remote server.

19. The system as claimed in claim 18, wherein the monitoring station is an unmanned monitoring station constitutes a portal located between a public roadway and an area of a yard where vehicles are parked and/or vehicle-assets are stored.

20. The system as claimed in claim 15, wherein the monitoring station is an unmanned monitoring station disposed along a public roadway.
